(19) United States
(12) Patent Application Publication
(10) Pub. No.: US 2026/0307218 A1
(43) Pub. Date: Oct. 8, 2026

(54) Dual Action Driver Ratchet

(71) Applicant: Grip Holdings LLC, Brandon, FL (US)

(72) Inventor: Simeon B. Kukucka, Brandon, FL (US)

(21) Appl. No.: 19/714,232

(22) Filed: Jun. 19, 2026

Related U.S. Application Data
(63) Continuation-in-part of application No. 29/957,414, filed on Aug. 13, 2024.

(51) Int. Cl. B25B 13/46; B25B 23/00; B25B 13/48

(52) U.S. Cl. CPC B25B 13/467; B25B 23/0035; B25B 13/481

(57) ABSTRACT

A gear driven ratcheting device with an optional rotational direction selector switch. The ratcheting device comprises a drive head, a torque-tool gear, and a wrench handle. The torque-tool gear is rotatably connected to the drive head, and the wrench handle is externally and laterally connected to the drive head. The torque-tool gear comprises at least one recessed section and a drive section. The recessed section extends laterally inward from a first base of the torque-tool gear to the drive section, and has an innermost diameter greater than the innermost diameter of the drive section. This arrangement enables the user to insert a torque-tool body further into the drive head, reducing the combined stack height of the ratchet device and torque-tool body. The shorter combination provides the end user with an overall shorter-profile tool for access to fasteners in confined spaces across automotive, aerospace, industrial, and maintenance, repair, and overhaul applications.

### FIELD OF THE INVENTION

The present invention relates generally to ratchet-type tools designed for tightening or loosening fasteners, in particular bolts and nuts. More specifically, the present invention is a gear driven ratcheting device incorporating a recessed section within the torque-tool gear that reduces the combined stack height of the ratchet head and an external torque-tool body, thereby providing improved access to fasteners in confined spaces.

### BACKGROUND OF THE INVENTION

Ratchet-type tools are widely used across automotive, aerospace, industrial, and maintenance, repair, and overhaul (MRO) applications to tighten or loosen threaded fasteners. A typical ratchet tool comprises a drive head housing an internal gear mechanism, a direction selector, and an external handle. The drive head receives an external torque-tool body — such as a socket or a driver bit — which in turn engages the fastener. The overall working length of the tool is determined by the combined stack height of the ratchet head and the torque-tool body projecting from it.

As modern equipment in the automotive, aerospace, electronics, and industrial sectors becomes increasingly compact, the physical space available around fastener locations has diminished. Sensors, wiring harnesses, structural members, and adjacent components frequently crowd the area surrounding a fastener, leaving minimal clearance for tool access. In many maintenance scenarios, a technician cannot insert a conventional ratchet and torque-tool combination into the available space because the combined stack height of the drive head and projecting torque-tool body exceeds the clearance envelope.

Existing approaches to this problem have included stubby or short-handle ratchets, flexible-head ratchets, and palm-style ratchet drivers. While these tools reduce the handle length or alter the head angle, they do not address the fundamental stack height created by the torque-tool body projecting outward from the drive head. The torque-tool body must still seat against the outer face of the drive head gear, meaning the full length of the bit or socket extends beyond the ratchet head regardless of handle configuration. This projection remains the limiting factor in tight-clearance applications.

What is needed is a ratchet device that reduces the combined stack height of the drive head and torque-tool body by allowing the torque-tool body to seat deeper into the drive head itself, rather than projecting entirely outward from it. Such a device would provide technicians with improved access to fasteners in confined spaces without sacrificing the torque delivery, directional control, or tool retention characteristics expected of a professional-grade ratchet.

### BRIEF DESCRIPTION OF THE DRAWINGS

FIG. 1 is a front perspective view of the present invention.

FIG. 2 is a rear perspective view of the present invention.

FIG. 3 is a front elevational view of the present invention.

FIG. 4 is a detailed view taken about circular section 4 in FIG. 1.

FIG. 5 is a detailed view taken about circular section 5 in FIG. 3.

FIG. 6 is a sectional view taken along line 6-6 in FIG. 5.

FIG. 7 is a first alternative sectional view taken along line 6-6 in FIG. 5.

FIG. 8 is a second alternative sectional view taken along line 6-6 in FIG. 5.

FIG. 9 is a front perspective view of the present invention, showing the external torque-tool body removed from the ratchet device.

FIG. 10 is a front perspective view of the present invention, showing the external torque-tool body attached to the ratchet device.

FIG. 11 is a sectional view taken along line 6-6 in FIG. 5, showing the external torque-tool body removed from the ratchet device.

FIG. 12 is a sectional view taken along line 6-6 in FIG. 5, showing the external torque-tool body attached to the ratchet device.

FIG. 13 is a rear elevational view of the present invention.

FIG. 14 is a sectional view taken along line 14-14 in FIG. 13.

### DETAILED DESCRIPTION OF THE INVENTION

All illustrations of the drawings are for the purpose of describing selected versions of the present invention and are not intended to limit the scope of the present invention.

The present invention is a gear driven ratchet device 1 with a rotational direction selector switch. The ratcheting device incorporates at least one recessed section 7, also referred to herein as an indexing recess, located within the torque-tool gear 3. By providing the recessed section within the torque-tool gear, the dual action driver ratchet enables the user to insert the torque-tool body 100 further into the ratchet head, thus making the ratchet head and torque-tool body combination shorter. This shorter combination provides the end user with an overall shorter-profile tool for use in confined-space applications across automotive, aerospace, electronics, industrial, and MRO environments.

The present invention is primarily configured as a handheld ratchet device for use with external torque-tool bodies including, but not limited to, driver bits and sockets. The torque-tool body 100 may be of a male configuration, wherein an externally shaped shank is received into the drive section 6 of the torque-tool gear 3, or a female configuration, wherein an internally shaped bore within the torque-tool body 100 receives a corresponding male member of the torque-tool gear 3. In either configuration, the at least one recessed section 7 of the torque-tool gear 3 permits the torque-tool body 100 to seat further into the drive head 2 than would be possible with a conventional ratchet gear having no recessed section, thereby reducing the combined stack height L6 of the torque-tool gear and the torque-tool body.

The drive section 6 of the torque-tool gear 3 may be sized to accommodate industry-standard drive formats including, but not limited to, ¼-inch, ⅜-inch, and ½-inch drive sizes. The overall dimensions of the drive head 2, torque-tool gear 3, and wrench handle 9 may be scaled proportionally to accommodate the selected drive size and the torque requirements of the intended application. The present invention is suitable for use across automotive, aerospace, electronics, industrial, and maintenance, repair, and overhaul (MRO) environments where fastener access is constrained by surrounding components.

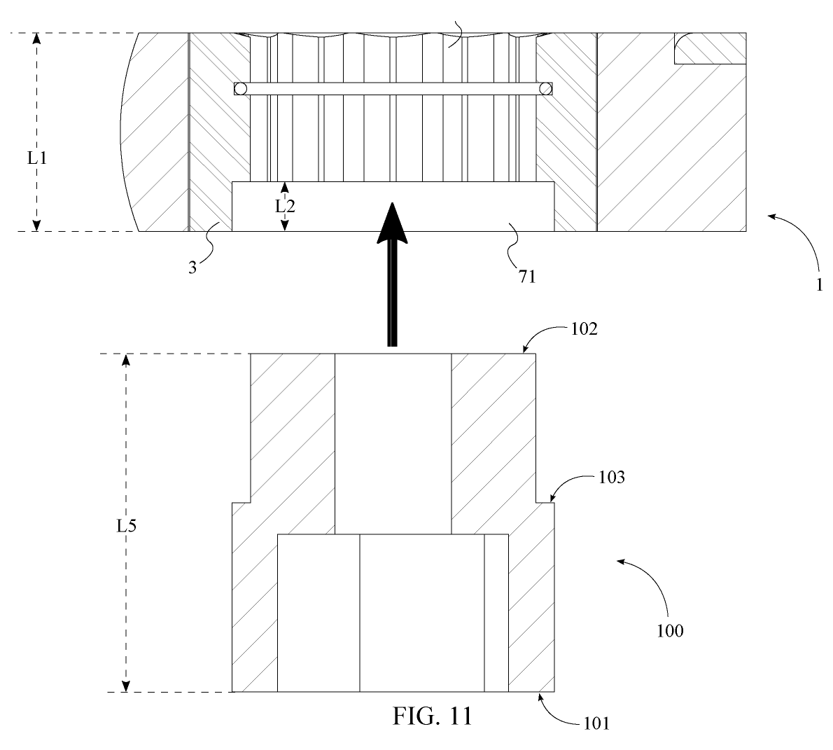

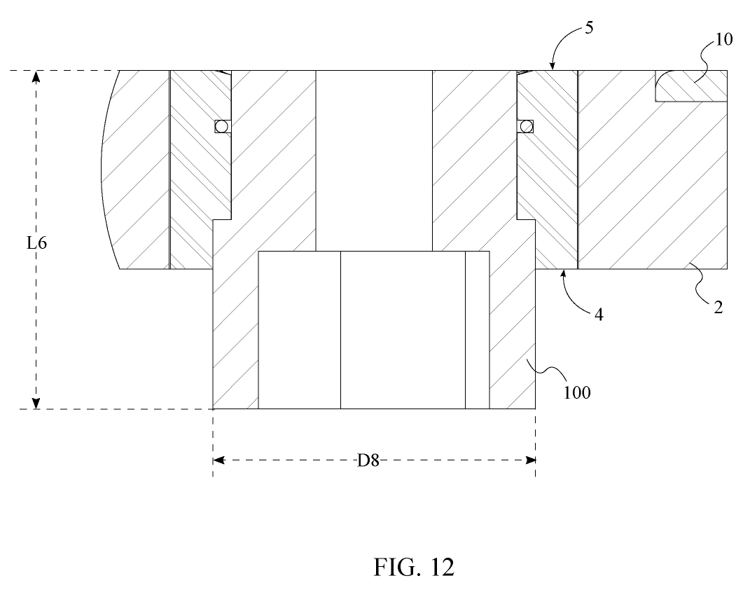

In a preferred embodiment as seen in FIG. 11, the torque-tool gear 3 is configured to receive a multi-grip socket bit or similar torque-tool body 100 having a working end 101 and an attachment end 102. The attachment end 102 is inserted into the drive section 6 of the torque-tool gear 3, and the at least one recessed section 71 provides clearance for a portion of the attachment end 102 or the transition 103 between the attachment end 102 and the working end 101 to nest within the torque-tool gear 3. As seen in FIG. 12, this nesting arrangement reduces the distance by which the working end 101 of the torque-tool body 100 projects beyond the drive head 2, providing the user with a shorter overall tool profile for use in confined-space applications.

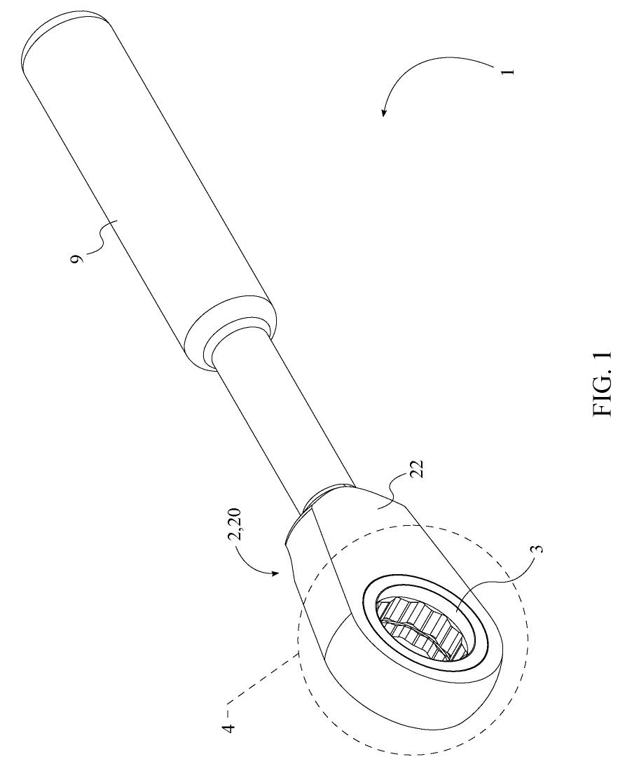

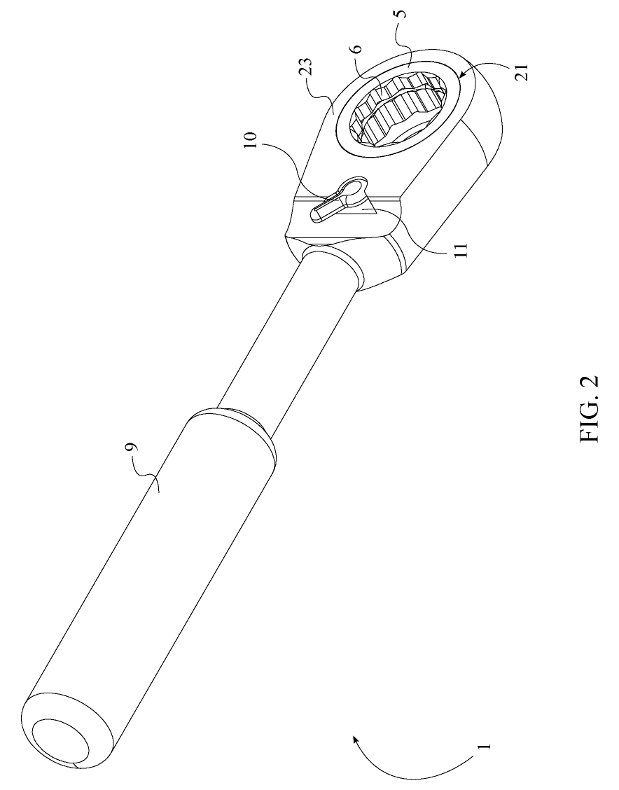

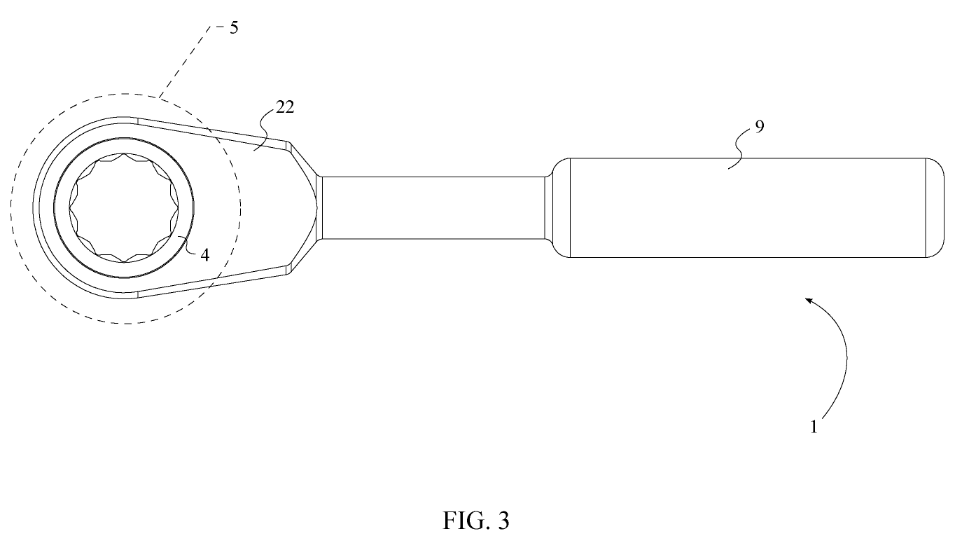

In reference to FIGS. 1-7, the present invention comprises a drive head 2 and a torque-tool gear 3. The torque-tool gear 3 is rotatably connected to the drive head 2. More specifically, the torque-tool gear 3 is operably coupled to an opening 21 of the drive head 2, such that the torque-tool gear 3 rotates independently of the drive head 2. The torque-tool gear 3 has an opening designed to fit a matching-sized external torque-tool body 100. The torque-tool body 100 can be male or female and is used as the physical structure to apply the corresponding force on the fastener head in either the tightening or loosening direction. For some fasteners, the torque-tool body 100 functions similar to a driver-bit that is sized to fit into an opening of the fastener head in an interlocking manner. The length L5, width, and diameter of the torque-tool body 100 may vary to fit different sized male and female fasteners.

Once properly fitted, the user can then apply torque to said fastener via an integrated ratchet mechanism 20. The ratchet mechanism 20 is housed within the drive head 2 and is operatively connected to the torque-tool gear 3. The ratchet mechanism 20 can be any gear-driven system known in the art and is not limited to any specific gear arrangement. Stated another way, the ratchet mechanism 20 can take the form of any suitable gear-driven system based on design, user, and or manufacturing requirements.

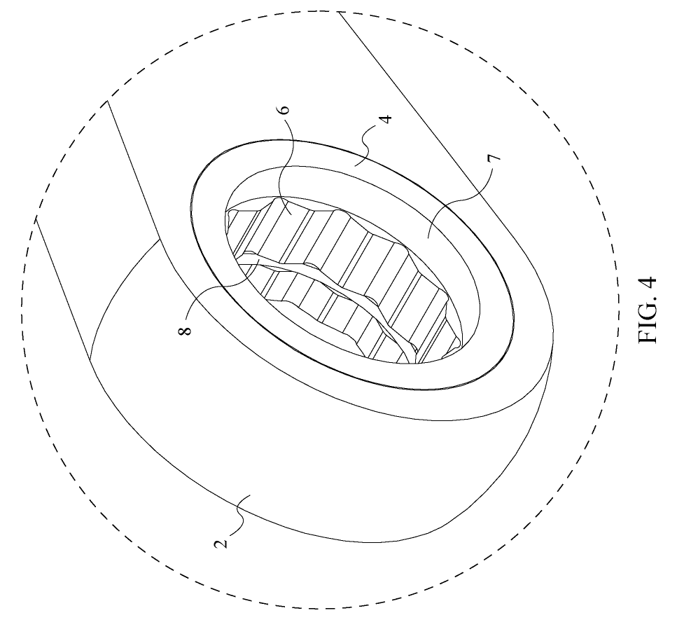

As best seen in FIGS. 4-6, the torque-tool gear 3 comprises a first base 4, a second base 5, a drive section 6, and at least one recessed section 7. The at least one recessed section 7, also referred to herein as an indexing recess, provides both clearance for the external torque-tool body 100 and axial alignment guidance as the torque-tool body is inserted into the torque-tool gear 3. The overall length, width, and diameter of the torque-tool gear 3 may vary to fit different sized fasteners. The first base 4 and the second base 5 are positioned opposite to each other about a pivot axis 31 of the torque-tool gear 3, thereby delineating a torque-tool length L1. The first base 4 is positioned adjacent to a first side 22 of the drive head 2, whereas the second base 5 is positioned adjacent to a second side 23 of the drive head 2.

A first recessed section 71 extends laterally inward, parallel with the pivot axis 31, from the first base 4 to the drive section 6, thereby delineating a first recessed length L2.

The proportion of the torque-tool length L1 occupied by the first recessed section 71 is governed by two competing functional constraints. The upper limit of the first recessed length L2 is determined by the minimum engagement length required for the drive section 6 to maintain secure and stable torque transfer to the external torque-tool body 100. As the first recessed length L2 increases relative to the torque-tool length L1, the remaining drive length L3 available for the plurality of bracing surfaces 61 to contact and brace the external torque-tool body 100 correspondingly decreases. Beyond a threshold proportion, the reduced bracing surface contact area becomes insufficient to resist lateral deflection, wobble, or disengagement of the torque-tool body under operating torque loads. The precise upper threshold may vary depending on drive size, material selection, manufacturing tolerances, and anticipated torque loads, but is generally observed to fall at or below approximately 50% of the torque-tool length L1 for typical hand-tool applications. At or above this proportion, the remaining drive section 6 may not provide adequate bracing surface engagement to ensure reliable tool retention and torque delivery during use, potentially resulting in tool body slippage, rounding of the drive surfaces, or ejection of the torque-tool body under load. However, it is understood that the present invention is not limited to the above, as materials and/or manufacturing methods enable the present invention to be made outside these parameters.

The lower limit of the first recessed length L2 is determined by the minimum recess depth at which the user obtains a meaningful reduction in the combined stack height of the torque-tool gear 3 and the external torque-tool body 100. A recessed section that is too shallow relative to the torque-tool length L1 permits only a negligible additional insertion depth of the torque-tool body 100, yielding no practical improvement in access to fasteners in confined spaces. The minimum useful first recessed length L2 is therefore the depth at which the torque-tool body 100 can seat sufficiently further into the torque-tool gear 3 to provide the user with a perceptible and operationally beneficial reduction in overall tool profile. This minimum threshold is generally observed to be at or above approximately 5% of the torque-tool length L1, below which the stack-height reduction is insufficient to provide a meaningful access advantage in typical confined-space MRO, automotive, aerospace, and industrial applications.

It is understood that the specific proportions of the first recessed length L2 relative to the torque-tool length L1 are not limited to fixed values and may be optimized within the functional constraints described above to suit a particular drive size, torque-tool body geometry, intended application, or user preference. The first recessed section 71 may be made as deep as practicable provided the remaining drive section 6 retains sufficient engagement to function as a reliable torque-transfer interface, and as shallow as the application requires provided the resulting stack-height reduction remains beneficial to the end user.

Accordingly, the first recessed length L2 is preferably less than 50% of the torque-tool length L1 but preferably greater than 5% of the torque-tool length L1.

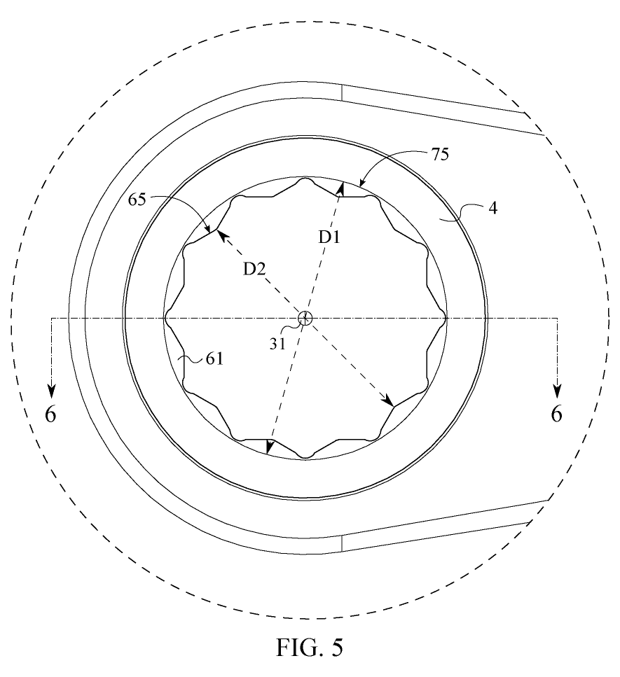

Regarding width, the first recessed section 71 has a circular or radii profile shape 75, thereby forming a thru hole that is axially aligned with the drive section 6. In other embodiments, the profile shape 75 of the first recessed section 71 can be angular to form a hexagon, a square, a dodecagon, or any other polygon shape. An innermost diameter D1 of the first recessed section 71 is slightly larger than the outer diameter D8 of the external torque-tool body 100, thereby forming a clearance gap between the torque-tool body 100 and the first recessed section 71. As a result, the torque-tool body 100 is capable of sliding further into the torque-tool gear 3, allowing the user to work in more confined spaces than a standard ratchet-type device having no recessed section. The at least one recessed section thereby permits the external torque-tool body 100 to seat into the torque-tool gear 3 such that the combined stack height L6 of the torque-tool gear 3 and the external torque-tool body 100 is less than the combined stack height of a ratchet device having no recessed section receiving the same external torque-tool body 100. In comparison to the drive section 6, the innermost diameter D1 of the first recessed section 71 is larger than the innermost diameter D2 of the drive section 6. As seen in FIG. 5, the innermost diameter D2 of the drive section 6 is defined as the shortest distance between any two diametrically opposing bracing surfaces 61. This arrangement acts as a stop and prevents the torque-tool body 100 from sliding through the first recessed section 71.

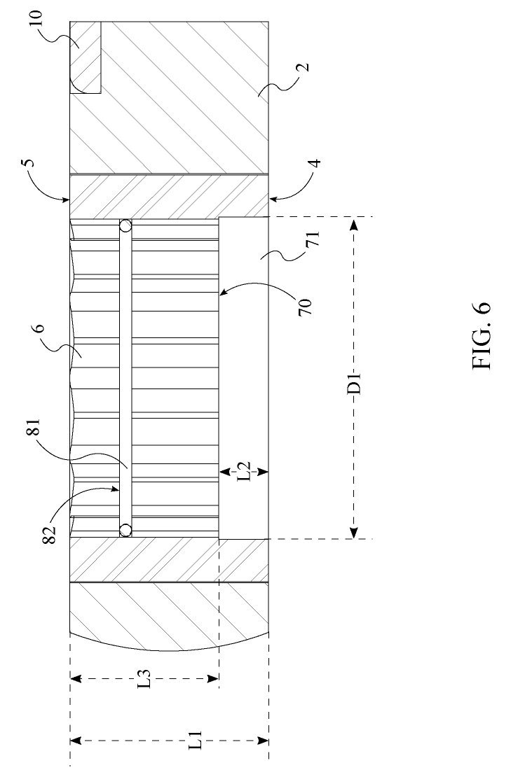

In the preferred embodiment as seen in FIG. 6, the drive section 6 extends laterally inward from a distal end 70 of the first recessed section 71 to the second base 5.

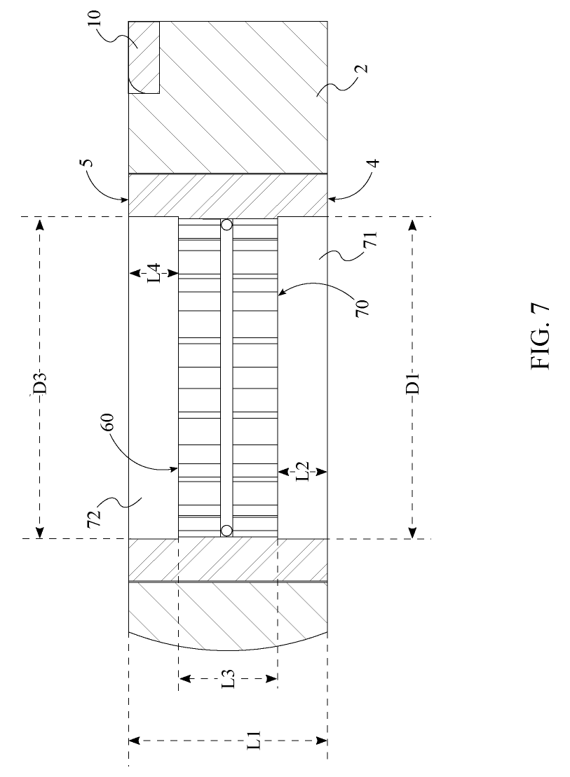

However, in an alternative embodiment as seen in FIG. 7, the drive section 6 is offset from the second base 5 by a second recessed section 72. In this embodiment, the drive section 6 extends laterally inward from the distal end 70 of the first recessed section 71 towards the second base 5, delineated by a drive length L3. On the opposite end, a second recessed section 72 extends laterally inward from the second base 5 to a distal end 60 of the drive section 6, delineated by a second recessed length L4. This arrangement allows the user to engage at least one recessed section 7 from either side of the ratchet device 1.

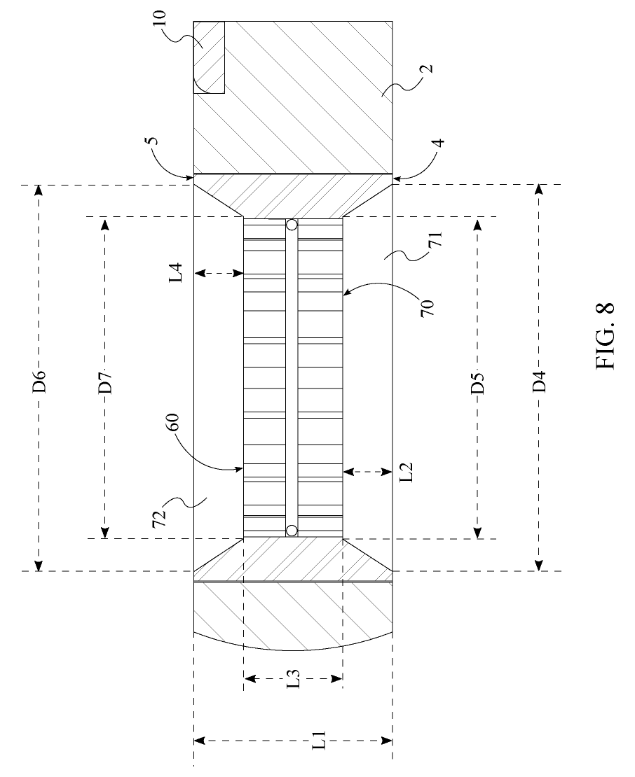

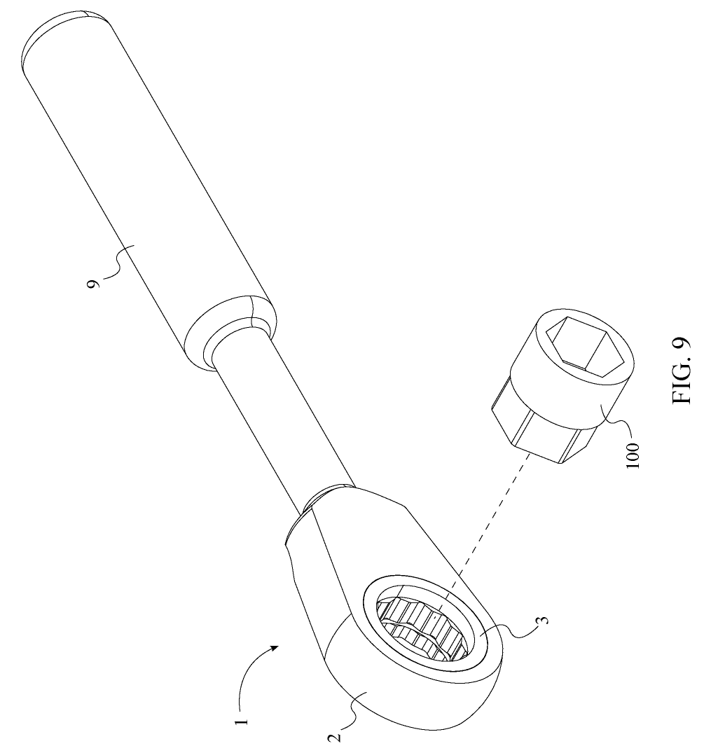

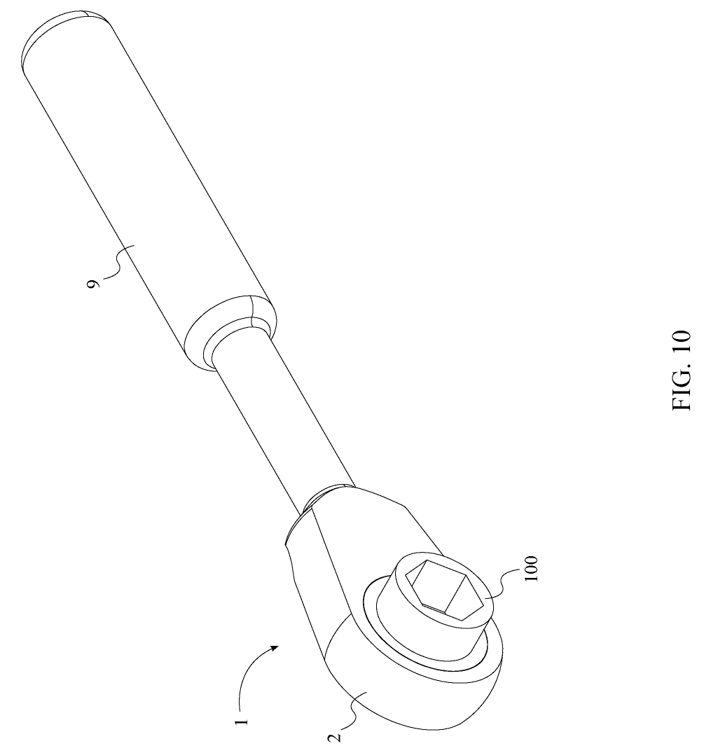

In reference to FIG. 8, in some embodiments, the at least one recessed section 7 may be tapered from the first base 4 to the distal end 70 of the first recessed section 71, wherein the recess diameter D4 measured adjacent to the first base 4 is greater than the recess diameter D5 measured at the distal end 70 of the first recessed section 71. Similarly, in some embodiments, the at least one recessed section 7 may be tapered from the second base 5 to the distal end 60 of the drive section 6, wherein the recess diameter D6 measured adjacent to the second base 5 is greater than the recess diameter D7 measured at the distal end 60 of the drive section 6. The tapered configuration may provide additional alignment guidance for the external torque-tool body 100 during insertion and may facilitate manufacturing of the torque-tool gear 3.

Where the torque-tool gear 3 comprises the second recessed section 72, the same functional constraints described above for the first recessed section 71 apply to the second recessed length L4. The combined proportion of the first recessed length L2 and the second recessed length L4 relative to the torque-tool length L1 is similarly bounded by the need to retain a drive length L3 sufficient for secure torque transfer. In this dual-recess embodiment, the drive section 6 must maintain adequate bracing surface contact even though recessed sections extend from both the first base 4 and the second base 5. The second recessed length L4 is preferably less than 50% of the torque-tool length L1 but preferably greater than 5% of the torque-tool length L1. Consequently, the drive length L3 can be less than 50% or greater than 50% of the torque-tool length L1 depending on the length of L2 or L2 and L4 combined.

Regarding width, the second recessed section 72 has a circular or radii profile shape 75, thereby forming a thru hole that is axially aligned with the drive section 6. In other embodiments, the profile shape 75 of the second recessed section 72 can be angular to form a hexagon, a square, a dodecagon, or any other polygon shape. An innermost diameter D3 of the second recessed section 72 is slightly larger than the outer diameter D8 of the external torque-tool body 100, thereby creating a clearance gap between the torque-tool body and the second recessed section 72. In comparison to the drive section 6, the innermost diameter D3 of the second recessed section 72 is larger than the innermost diameter D2 of the drive section 6.

As can be seen in FIG. 5, the drive section 6 comprises a plurality of bracing surfaces 61. The plurality of bracing surfaces 61 is radially distributed about the pivot axis 31 of the torque-tool gear 3. The plurality of bracing surfaces 61 delineates a profile shape 65 that is complementary to the external torque-tool body 100 being engaged. In the preferred embodiment, each of the bracing surfaces 61 is angular. Thus, the profile shape 65 formed by the angular bracing surfaces can include but is not limited to a hexagon, a square, or a dodecagon. In other embodiments, each of the bracing surfaces 61 may be angular, radial, radii, or lobular, or may be a combination of some or multiple shapes.

The present invention further comprises a retaining system 8. The retaining system 8 is configured to secure the torque-tool body 100 within the torque-tool gear 3. Preferably, the retaining system 8 is integrated into the drive section 6. However, in other embodiments, the retaining system 8 may be integrated into the first recessed section 71 or the second recessed section 72. In the preferred embodiment, as seen in FIGS. 6-7, the retaining system comprises a retaining ring 81. The retaining ring 81 is positioned within an annular groove 82 located either within the drive section 6 or within the recessed section 7. It is understood that the retaining system 8 is not limited to a retaining ring 81. In other embodiments, the retaining system 8 may be in the form of a ball bearing system, an alternative clip, a friction or magnet system, or any other suitable retaining device.

The present invention further comprises a wrench handle 9. The wrench handle 9 is externally and laterally connected to the drive head 2 and acts as a lever arm to substantially increase the torque force applied to the fastener. The length of the wrench handle 9 may vary depending on the torque force required to remove the fastener. A longer wrench handle 9 produces a greater torque force and vice versa. Furthermore, the general shape, design, and material composition of the wrench handle 9 may also vary to accommodate the needs of the user. For example, the wrench handle 9 may be padded at various regions to alter the handling characteristics of the tool to increase ease of use and comfort for the user.

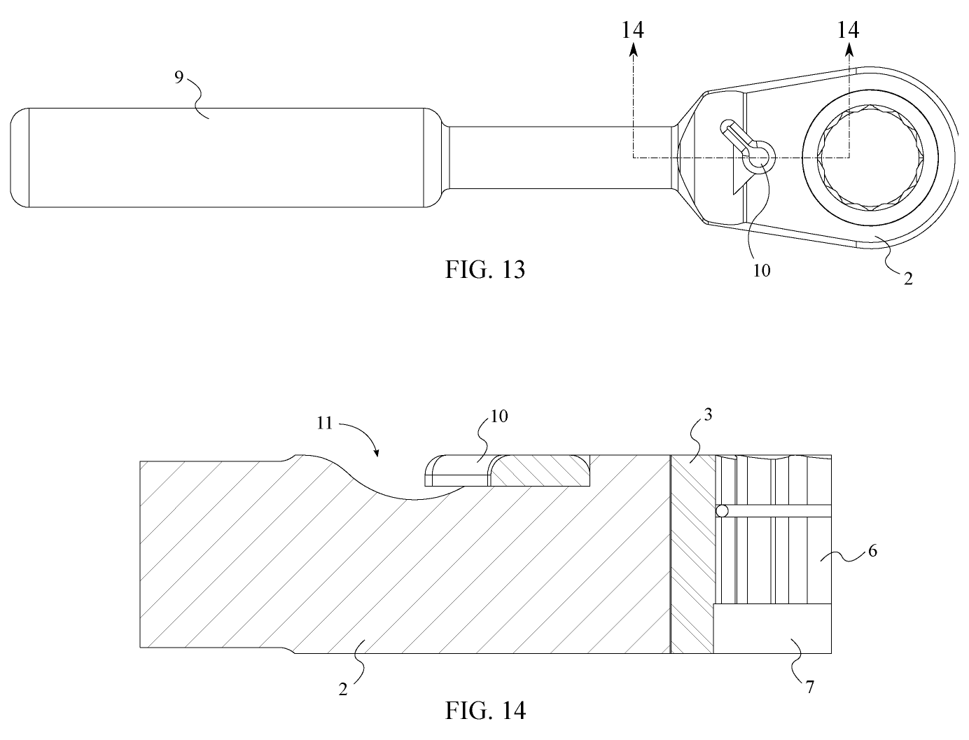

As can be seen in FIGS. 13-14, the present invention further comprises a direction selector switch 10. The direction selector switch 10 allows the torque-tool gear 3 to tighten or loosen a fastener in one direction while slipping freely in the other. Preferably, the direction selector switch 10 is externally mounted to the second side 23 of the drive head 2, wherein the second side 23 of the drive head 2 is positioned adjacent to the second base 5. However, in other embodiments, the direction selector switch 10 can be externally mounted to the first side 22 of the drive head 2, wherein the first side 22 of the drive head 2 is positioned adjacent to the first base 4. The direction selector switch 10 is operatively connected to the torque-tool gear 3. Activating the direction selector switch 10 enables the user to switch the torque-tool gear 3 from a tightening configuration to a loosening configuration or vice versa.

The direction selector switch 10 is preferably recessed into the second side 23 of the drive head 2, wherein the switch 10 is mounted within a switch recess section 11 and is preferably flush with the second side 23 or slightly protruding from the second side 23.

The switch recess section 11 is a concave channel preferably oriented perpendicular with the wrench handle 9 and extending laterally inward into the second side 23 towards the first side 22. Alternatively, the switch recess section 11 can be positioned on the opposite side of the drive head 2, extending laterally inward into the first side 22 towards the second side 23. The switch recess section 11 extends from left side to right side for proper clearance to operate the direction selector switch 10. In this arrangement, the switch recess section 11 enables the direction selector switch 10 to be housed within the concave channel and provides easier switching from left to right. The switch recess section 11 may be any shape or combination of any shapes, as long as the switch recess section 11 is a concave channel.

In some embodiments, the user may prefer no direction selector switch 10 on the drive head 2. In these embodiments, the ratchet device 1 is configured without the direction selector switch 10.

In alternative embodiments, the user may prefer to have no direction selector switch 10 especially where both a first recessed section 71 and a second recessed section 72 are incorporated into the torque-tool gear 3.

Although the invention has been explained in relation to its preferred embodiment, it is to be understood that many other possible modifications and variations can be made without departing from the spirit and scope of the invention as hereinafter claimed.

What is claimed is:

1. A ratchet device comprising:
a drive head;
a torque-tool gear;
the torque-tool gear being rotatably connected to the drive head;
the torque-tool gear comprising a first base, a second base, a drive section, and at least one recessed section;
the torque-tool gear extending laterally from the first base to the second base, delineated by a torque-tool length;
a first recessed section extending laterally from the first base to the drive section, delineated by a first recessed length;
the drive section comprising a plurality of bracing surfaces; and
the plurality of bracing surfaces being radially distributed about a pivot axis of the torque-tool gear.

2. The ratchet device as claimed in claim 1 comprising:
a wrench handle; and
the wrench handle being externally and laterally connected to the drive head.

3. The ratchet device as claimed in claim 1, wherein the drive section extends laterally from the first recessed section to the second base.

4. The ratchet device as claimed in claim 3, wherein an innermost diameter of the first recessed section is greater than an innermost diameter of the drive section.

5. The ratchet device as claimed in claim 1 comprising:
the drive section extending laterally from the first recessed section towards the second base, delineated by a drive length; and
a second recessed section extending laterally from the second base to the drive section, delineated by a second recessed length.

6. The ratchet device as claimed in claim 5 comprising:
an innermost diameter of the first recessed section being greater than an innermost diameter of the drive section; and
an innermost diameter of the second recessed section being greater than an innermost diameter of the drive section.

7. The ratchet device as claimed in claim 1, wherein each of the plurality of bracing surfaces is angular.

8. The ratchet device as claimed in claim 1, wherein a profile shape of the at least one recessed section is circular.

9. The ratchet device as claimed in claim 1, wherein a profile shape of the at least one recessed section is angular.

10. The ratchet device as claimed in claim 1 comprising:
a retaining system; and
the retaining system being configured to secure an external torque-tool body to the torque-tool gear.

11. The ratchet device as claimed in claim 10 comprising:
the retaining system comprising a retaining ring; and
the retaining ring being integrated into the drive section.

12. The ratchet device as claimed in claim 1 comprising:
a direction selector switch;
a switch recess section;
the direction selector switch being operatively connected to the torque-tool gear;
a first side of the drive head being adjacently positioned to the first base;
a second side of the drive head being adjacently positioned to the second base;
the direction selector switch being externally mounted to the first side of the drive head;
the switch recess section being a concave channel formed in the first side of the drive head;
the direction selector switch being housed within the switch recess section; and
the direction selector switch being substantially flush with or slightly protruding from the first side of the drive head.

13. The ratchet device as claimed in claim 1 comprising:
the at least one recessed section being tapered from the first base to a distal end of the first recessed section; and
a recess diameter measured adjacent to the first base being greater than a recess diameter measured at the distal end of the first recessed section.

14. A ratchet device comprising:
a drive head;
a torque-tool gear rotatably connected to the drive head;
the torque-tool gear comprising a first base, a second base, a drive section, and at least one recessed section;
the torque-tool gear extending laterally from the first base to the second base, delineated by a torque-tool length;
a first recessed section extending laterally from the first base to the drive section, delineated by a first recessed length;
the drive section comprising a plurality of bracing surfaces;
the plurality of bracing surfaces being radially distributed about a pivot axis of the torque-tool gear;
an innermost diameter of the first recessed section being greater than an innermost diameter of the drive section; and
the first recessed section providing clearance for an external torque-tool body to seat further into the torque-tool gear than the drive section alone would permit, thereby reducing a combined stack height of the torque-tool gear and the external torque-tool body.

15. The ratchet device as claimed in claim 14 comprising:
a second recessed section extending laterally from the second base to the drive section, delineated by a second recessed length; and
an innermost diameter of the second recessed section being greater than the innermost diameter of the drive section.

16. The ratchet device as claimed in claim 14, wherein the torque-tool gear is configured to receive an external torque-tool body of a male configuration wherein an externally shaped shank is received into the drive section, or a female configuration wherein an internally shaped bore within the torque-tool body receives a corresponding male member of the torque-tool gear.

17. The ratchet device as claimed in claim 14 comprising:
a retaining system;
the retaining ring being integrated into the first recessed section; and
the retaining system being configured to secure the external torque-tool body to the torque-tool gear.

18. The ratchet device as claimed in claim 14 comprising:
a retaining system;
the retaining ring being integrated into the drive section; and
the retaining system being configured to secure the external torque-tool body to the torque-tool gear.

19. The ratchet device as claimed in claim 14, wherein each of the plurality of bracing surfaces is angular, delineating a profile shape selected from a hexagon, a square, and a dodecagon.

20. The ratchet device as claimed in claim 14, wherein a profile shape of the first recessed section is circular.

21. The ratchet device as claimed in claim 14, wherein a profile shape of the first recessed section is angular.

22. The ratchet device as claimed in claim 14, wherein the drive section is sized to accommodate an industry-standard drive format selected from ¼-inch, ⅜-inch, and ½-inch drive sizes.

23. The ratchet device as claimed in claim 14, wherein the at least one recessed section permits the external torque-tool body to seat into the torque-tool gear such that a combined stack height of the torque-tool gear and the external torque-tool body is less than a combined stack height of a ratchet device having no recessed section receiving the same external torque-tool body.

24. The ratchet device as claimed in claim 14 comprising;
the external torque-tool body being a multi-grip socket bit;
the multi-grip socket bit comprising a working end and an attachment end;
the attachment end being inserted into the drive section of the torque-tool gear; and
a portion of the attachment end or a transition between the attachment end and the working end being nested within the at least one recessed section.

25. The ratchet device as claimed in claim 14 comprising:
a direction selector switch;
the direction selector switch being operatively connected to the torque-tool gear; and
the direction selector switch being externally mounted to a second side of the drive head positioned adjacent to the second base.

26. The ratchet device as claimed in claim 14 comprising;
a direction selector switch;
the direction selector switch being operatively connected to the torque-tool gear; and
the direction selector switch being externally mounted to a first side of the drive head positioned adjacent to the first base.

27. The ratchet device as claimed in claim 12 comprising;
the switch recess section extending laterally inward into the first side towards the second side;
the switch recess section extending from left side to right side for proper clearance to operate the direction selector switch.

28. The ratchet device as claimed in claim 14 comprising:
the at least one recessed section being tapered from the first base to a distal end of the first recessed section; and
a recess diameter measured adjacent to the first base being greater than a recess diameter measured at the distal end of the first recessed section.

29. The ratchet device as claimed in claim 1, wherein the ratchet device is configured without a direction selector switch.

30. The ratchet device as claimed in claim 14 comprising:
a ratchet mechanism;
the ratchet mechanism housed within the drive head; and
the ratchet mechanism operatively connected to the torque-tool gear.
